(19) United States
(12) Patent Application Publication
(10) Pub. No.: US 2009/0156035 A1
(43) Pub. Date: Jun. 18, 2009

(54) INTERCOUPLING ELECTRICAL DEVICES

(75) Inventors: Burt Fisher, Coventry, RI (US); Glenn Goodman, Cumberland, RI (US)

Correspondence Address: OCCHIUTI ROHLICEK & TSAO, LLP, 10 FAWCETT STREET, CAMBRIDGE, MA, 02138, US

(73) Assignee: Advanced Interconnections Corporation, West Warwick, RI (US)

(21) Appl. No.: 11/959,044

(22) Filed: Dec. 18, 2007

(51) Int. Cl. H01R 29/00; H01R 24/04

(52) U.S. Cl. 439/189; 439/668

(57) ABSTRACT

A terminal includes a resilient member extending from a first end to a second end, the first end including a contact portion configured to engage a male contact and the second end including a retention feature configured to hold the male contact in place against a first force applied to the male contact by the first end. A plurality of such terminals can be included within an assembly that includes: a first insulative support member defining a first plurality of apertures extending from first surface of the first insulative support member to an opposite second surface of the first insulative support member; with the plurality of terminals received in the apertures.

### TECHNICAL FIELD

This invention relates to intercoupling electrical devices.

### BACKGROUND

Sockets are used to allow particular IC packages to be interchanged without permanent connection to a circuit board. More recently, sockets for use with BGA and LGA packages have been developed to allow these packages to be non-permanently connected (e.g., for programming, debugging, and/or testing) to a circuit board.

### SUMMARY

In one aspect, an assembly includes: a first insulative support member defining a first plurality of apertures extending from a first surface of the first insulative support member to an opposite second surface of the first insulative support member; and a plurality of terminals received in the apertures, each terminal comprising a resilient member extending from a first end to a second end, the first end including a contact portion configured to engage a male contact and the second end including a retention feature configured to engage the male contact and hold the male contact in place against a first force applied to the male contact by the first end.

In another aspect, a terminal includes: an electrically conductive resilient member extending from a first end to a second end, the first end including a contact portion configured to engage a male contact and the second end including a retention feature configured to engage the male contact and hold the male contact in place against a first force applied to the male contact by the first end.

In another aspect, an assembly includes: a first insulative support member defining a first plurality of apertures extending from a first surface of the first insulative support member to an opposite second surface of the first insulative support member; a plurality of terminals received in the apertures, each terminal comprising a resilient member extending from a first end to a second end, the first end configured to apply the first force substantially along an axis of the male contact, the first end including a contact portion configured to engage a male contact and the second end configured to apply a second force substantially across the axis of the male contact, the second end including a retention feature configured to engage the male contact and hold the male contact in place against a first force applied to the male contact by the first end; a second insulative support member defining a second plurality of holes extending from a first surface of the second insulative support member to an opposite second surface of the second insulative support member; and a plurality of male contacts received in the apertures, each male contact comprising a surface feature configured to engage the retention feature of a corresponding terminal.

Embodiments can include one or more of the following features.

In some embodiments, the first end is configured to apply the first force substantially along an axis of the male contact. In some cases, the second end is configured to apply a second force substantially across the axis of the male contact.

In some embodiments, assemblies further include: a second insulative support member defining a second plurality of holes extending from a first surface of the second insulative support member to an opposite second surface of the second insulative support member; and a plurality of male contacts received in the apertures. In some cases, each male contact comprises a surface feature configured to engage the retention feature of a corresponding terminal.

In some embodiments, the resilient member of each terminal defines an axis and the plurality of terminals are disposed such that axes of the terminals are substantially parallel. In some cases, adjacent terminals of the plurality of terminals are disposed with opposite orientations.

In some embodiments, the resilient member comprises a first leg, a second leg, and a transition region, the first leg attached to the second leg by the transition region such that the first leg is substantially parallel to the second leg when the terminal is in an unconstrained rest position. In some cases, each terminal further includes a base attached to the first leg, the base spaced apart from the contact portion by a first distance and the base spaced apart from the transition region by a second distance that is greater than the first distance. In some cases, the resilient member further includes a third leg extending substantially linearly from the first leg to the second end, the third leg attached to the first leg such that the third leg is substantially perpendicular to the first leg in the first position. The third leg can have a length that is greater than the first distance.

In some embodiments, the retention feature is a protrusion extending outward from the third leg.

In some embodiments, terminals also include a male contact extending from the base on a first side of the base opposite a second side of the base to which the resilient member is attached.

In some embodiments, the first position is an unconstrained rest position.

In use, individual terminals can each exert a force on a corresponding contact, the force including components parallel to and components perpendicular to a surface of the intercoupling component in which the terminals are mounted. Intercoupling components can have terminals that are arranged in an alternating configuration with first ends of adjacent terminals disposed towards opposite sides of the intercoupling components. In some cases, the lateral components of the individual forces cancel each other out and provide a resultant total force is substantially orthogonal to the surface of the intercoupling component. In some cases, this balance of lateral forces can also provide a reliable electrical connection by reducing the tendency of contacts engaging the terminals to be displaced laterally away from the terminals.

Intercoupling components enable temporary and/or semi-permanent attachment and electrically connection of electrical devices to each other. Such attachment can reduce the amount of time required for programming, debugging, and/or testing electrical devices and can reduce damage associated with such testing. Such attachment can also facilitate the modular construction of assemblies including multiple electrical devices. Such attachment can also allow individual IC packages to be interchanged without permanent connection to circuit board.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIGS. 1A and 1B are perspective views of an electrical connector in use.

FIGS. 2A and 2B are, respectively, a perspective view and a cross-sectional view of the electrical connector of FIG. 1.

FIGS. 3A and 3B are, respectively, a perspective view and a cross-sectional view of the female assembly of the electrical connector of FIGS. 2A and 2B.

FIG. 4 is a side view of an embodiment of a terminal.

FIG. 5 is a perspective view of the male assembly of the electrical connector of FIGS. 2A and 2B.

FIGS. 6A and 6B are cross-sectional side views of embodiments of contact heads.

Like reference symbols in the various drawings indicate like elements.

### DETAILED DESCRIPTION

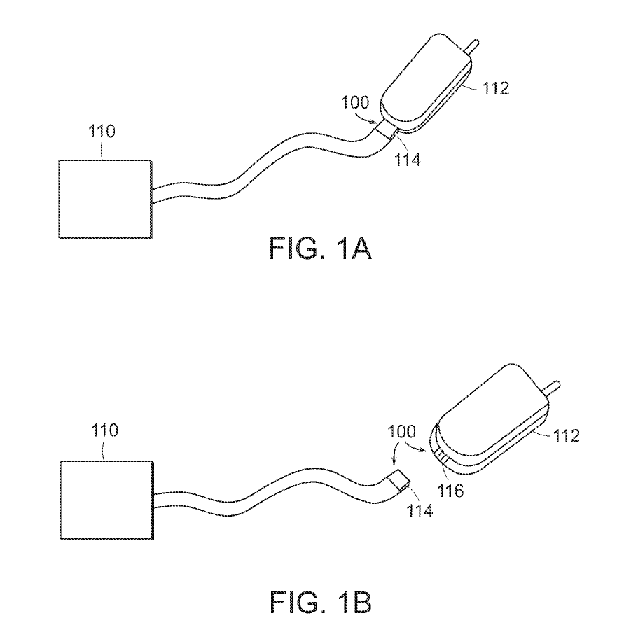

Referring to FIGS. 1A and 1B, an intercoupling component 100 for temporarily and/or semi-permanently attaching and electrically connecting electrical devices to each other is shown. Intercoupling component 100 includes a female assembly 114 and a male assembly 116. In the illustrated application, female assembly 114 is attached to a testing device 110 and a male assembly 116 mounted in a cell phone 112.

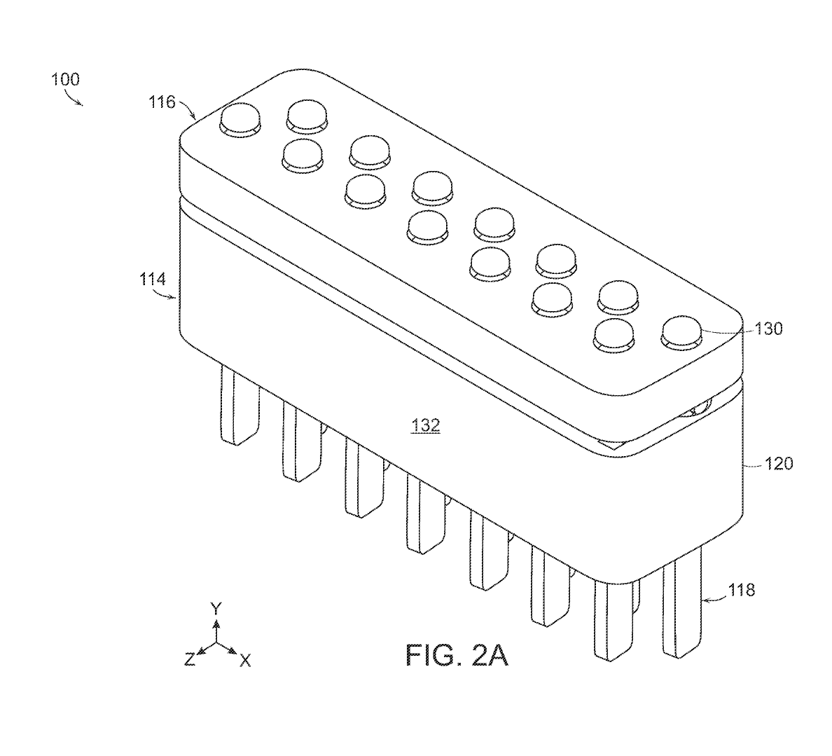

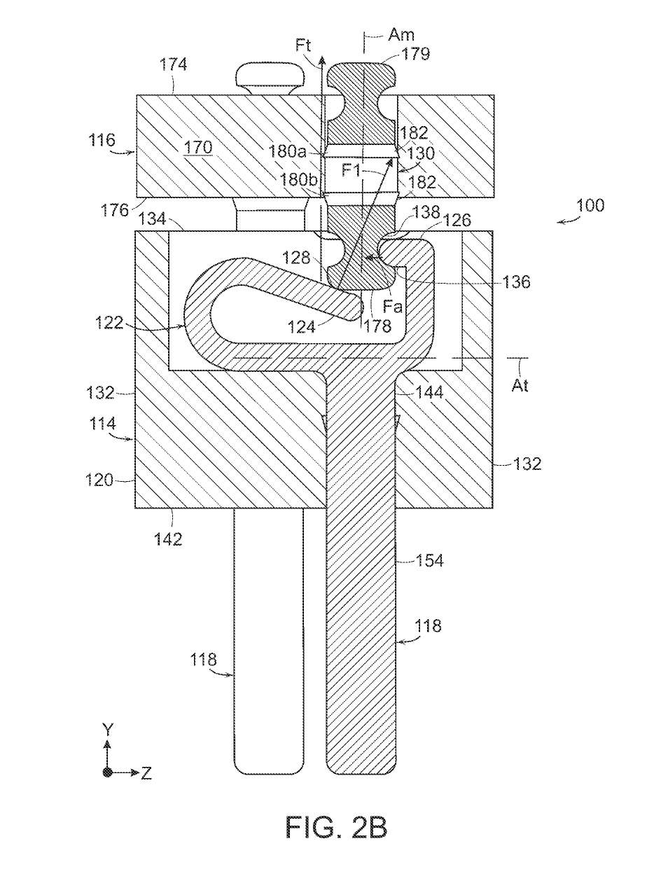

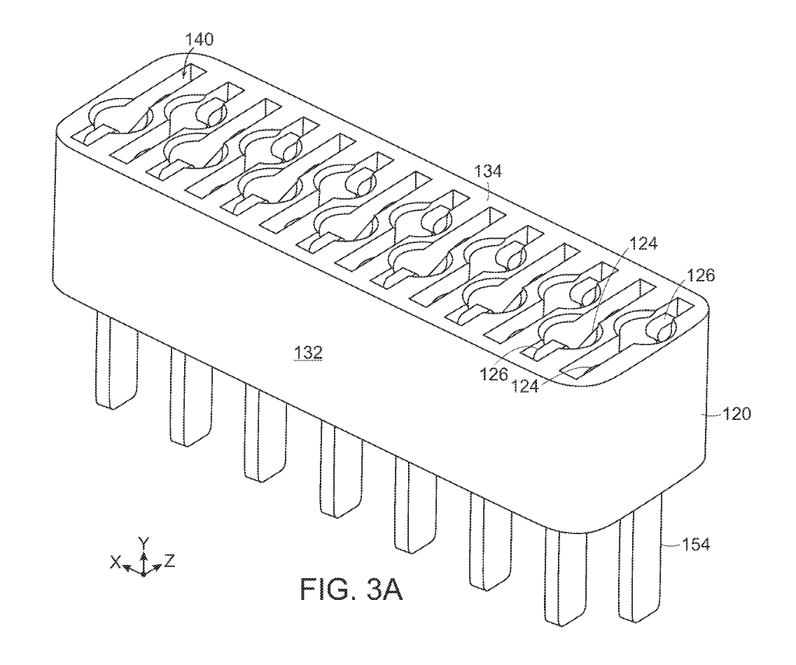

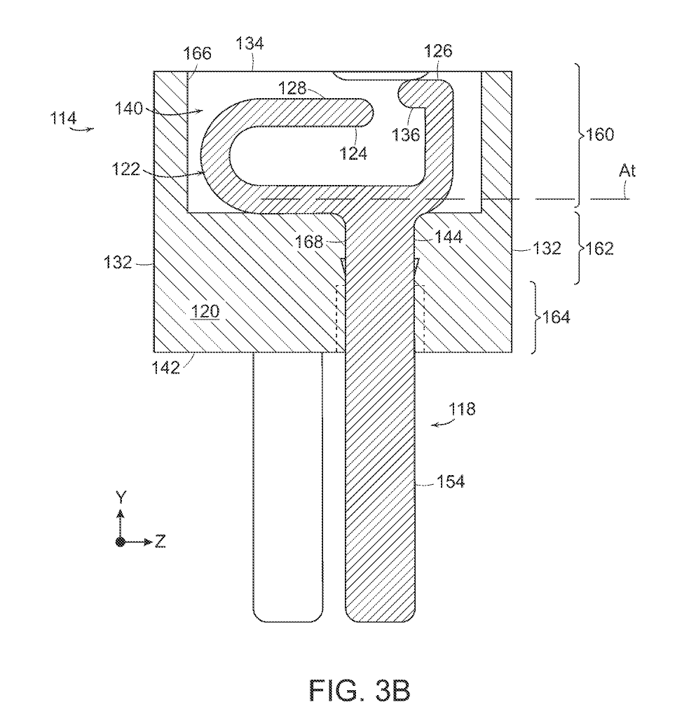

Referring to FIGS. 2A, 2B, 3A and 3B, female assembly 114 includes multiple terminals 118 disposed within an insulative support member 120. Each terminal 118 includes a resilient member 122 extending from a first end 124 to a second end 126. First ends 124 include contact portions 128 configured to engage male contacts 130 of male assembly 116. First end 124 of resilient member 118 is configured to apply a first force F₁ substantially along an axis Aₘ of a male contact 130 engaging first end 124 (see FIG. 2B). In contrast, second end 126 is configured to apply a second force F₂ across axis Aₘ of male contact 130. A mechanical bias of terminals 118 towards an unconstrained rest position (see FIG. 3B) causes each first end 124 of each terminal 118 to exert first force F₁ against corresponding male contact 130 when male assembly 116 is pressed into engagement with female assembly 114. Second ends 126 include retention features 136 configured to hold male contacts 130 in place against first forces F₁.

As shown more clearly in FIG. 3A, terminals 118 are arranged in an alternating configuration with first ends 124 of adjacent terminals 118 disposed towards opposite lateral faces 132 of insulative support member 120. Each terminal 118 includes a base 119 lying in a plane having an axis Aₜ disposed such that the terminals are substantially parallel and adjacent to terminals 118 disposed with opposite orientations. A resultant total force Fₜ is the sum of individual first forces F₁. Components of individual first forces F₁ parallel to broad face 134 of support member 120 tend to cancel such that resultant total force Fₜ is substantially orthogonal to the broad face 134. In some cases, this balance of lateral force can reduce the tendency of male contacts and/or the associated intercoupling component to move laterally. A reliable electrical connection can be provided by reducing the tendency of contact engaging the terminals to be displaced laterally away from the terminals.

Referring again to FIGS. 1A and 1B, in one application, intercoupling components 100 are used in testing multiple cell phones 112. In this exemplary use, female assembly 114 is soldered to testing assembly 110 which is adapted to test cell phone 112. Each cell phone 112 has a male assembly 116 and the combined unit (i.e., cell phone 112 and male assembly 116) is positioned with male contacts 130 of male assembly 116 aligned with contact portions 128 of corresponding terminals 118. As male assembly 116 and attached cell phone 112 are pressed towards female assembly 114 and attached testing assembly 110, male assembly 116 engages female assembly 114. Male contacts 130 initially displace retention features 136 and second ends 126 of resilient members 118 laterally. As male contacts 130 engage contact portions 128 of resilient members 118, first ends 124 of resilient members 118 are displaced from their unconstrained rest position. Retention features 136 engage grooves 138 on male contacts 130. The engagement between retention features 136 and grooves 138 acts to hold male contacts 130 in place against first forces F₁. Male contacts 130 are electrically connected with resilient members 118 at two points: contact portions 128 and retention features 136. After testing of cell phone 112 is complete, cell phone 112 and male assembly 116 are disengaged from female assembly 114.

Intercoupling components 100 enable temporary and/or semi-permanent attachment and electrical connection of electrical devices 110, 112 to each other. Such attachment can reduce the amount of time required for testing electrical devices and can reduce damage associated with such testing. Such attachment can also facilitate the modular construction of assemblies including multiple electrical devices. In some embodiments, intercoupling components are configured to attach and electrically connect other electrical devices including, for example, electronic games and other hand-held electronic devices which can be programmed, debugged, and/or tested.

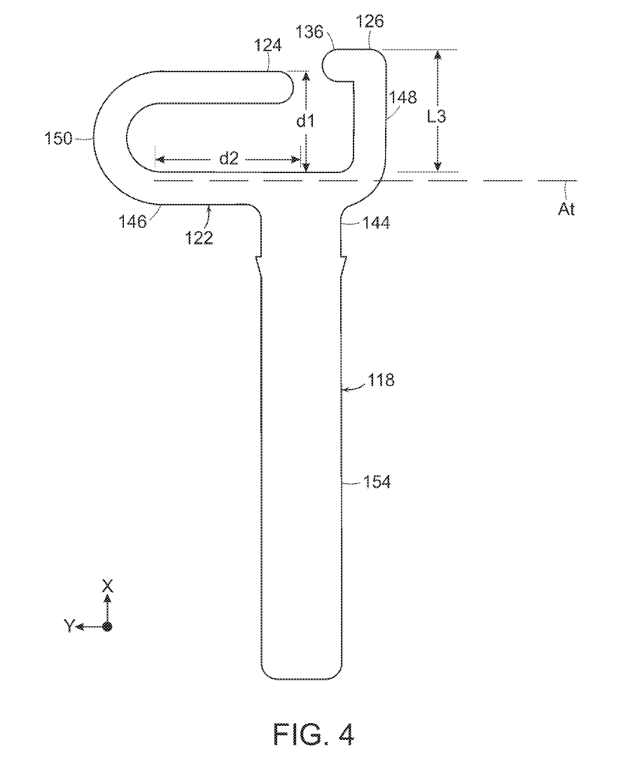

Referring to FIG. 4, terminal 118 is stamped from a sheet of conductive material (e.g., beryllium-copper) or can be etched from a sheet of conductive materials or wire-formed from conductive wire. Beryllium-copper is well-suited for terminal 118 as it is both electrically-conductive and, under some conditions, naturally regains its original shape or position after being bent, stretched, or compressed. Resilient member 122 has a mechanical bias towards an unconstrained rest position. Resilient member 122 can also be formed of other resilient, electrically-conductive material including, for example, other copper alloys and/or phosphor-bronze.

Resilient member 122 of terminal 118 is shown in an unconstrained rest position and is formed as a pair of legs; in particular, a first leg 146 and a second leg 148. First leg 146 is U-shaped having an end 124 extending to a junction region of a base 144 and second leg 148. Second leg 148 is D-shaped having an end 126 extending to junction region of base 144, which is integrally formed to male contact 154. The junction region lies along a terminal axis Aₜ.

In its unconstrained rest position, contact portion 128 at end 124 of first leg 146 is substantially parallel to the junction region of base 144. First leg 146 has a length d₂ and is spaced from base 144 by a first distance d₁, length d₂ being greater than first distance d₁. Length d₂ and first distance d₁ are selected to provide a sufficient bias when male contact 130 is positioned in contact with resilient member 122. First leg 146 is attached to the junction region by a curved transition region 150.

Second leg 148 is attached to base 144 at the junction region such that the second leg 148 is substantially perpendicular to first leg 146 in the unconstrained rest position. Second leg 148 has a length L₃ that is greater than first distance d₁. Second end 126 of resilient member 118 is disposed farther from base 144 than first end 124 of resilient member 118.

End 126 of second leg 148 serves as a retention feature 136 configured to hold male contact 130 in place against first force F₁ applied to male contact 130 by end 124 of first leg 146. Retention feature 136 is in the form of a protrusion and extends toward end 124 of first leg 146 and is captured within, for example, groove 138 of male contact 130 (see FIG. 2B). The depth of groove 138 and length of retention feature 136 are selected to ensure that male contact 130 is sufficiently retained in contact with terminal 118. For example, when groove 138 is made shallower or the length of retention feature 136 is made shorter, male contact 130 is more easily removed from terminal 118. Certain embodiments of terminals include other retention features such as, for example, a groove designed to receive a protrusion extending outward from the surface of a corresponding male contact. Other embodiments of terminals do not include any retention features.

Referring again to FIGS. 3A and 3B, insulative support member 120 of female assembly 114 has a first plurality of apertures 140 extending from broad face 134 of insulative support member 120 to an opposite broad face 142. Interior walls 166 of insulative support member 120 define apertures 140 that each include a first section 160, a second section 162, and, in some embodiments, a third section 164. First sections 160 are sized to receive resilient members 118 and are open towards broad face 134 of insulative support member 120. Second sections 162 have a smaller transverse cross-sectional area than first sections 160 and are sized to receive base 144 such that walls 166 of insulative support member engage outer surfaces 168 of base 144. Second sections 162 are positioned in relative to first sections 160 such that there is space between resilient members 122 and portions of walls 166 adjacent transition region 122 and third leg 152 when terminals 118 are installed in apertures 140. Optional third sections 164 can have a larger transverse cross-sectional area than second sections 162. In some embodiments, third sections 164 are sized to facilitate the use of an adhesive such as, for example, chipboard glue to help maintain engagement between terminals 118 and insulative support member 120.

Insulative support member 120 is molded of an electrically insulative thermoplastic (e.g., liquid crystal polymer). In some other embodiments, insulative support members 120 are machined out of an insulating material such as, for example, FR-4. Terminals 118 are inserted into apertures 140 through first sections 160. Terminals 118 are pressed into apertures 140 until bases 144 engage walls 166 of insulative support member 120. Bases 144 are press-fit into second sections 162 of apertures 140 with male contacts 154 of terminals 118 extending out of insulative support member 120 through third sections 164 of apertures. Resilient members 122 are disposed in first sections 160 of apertures 140.

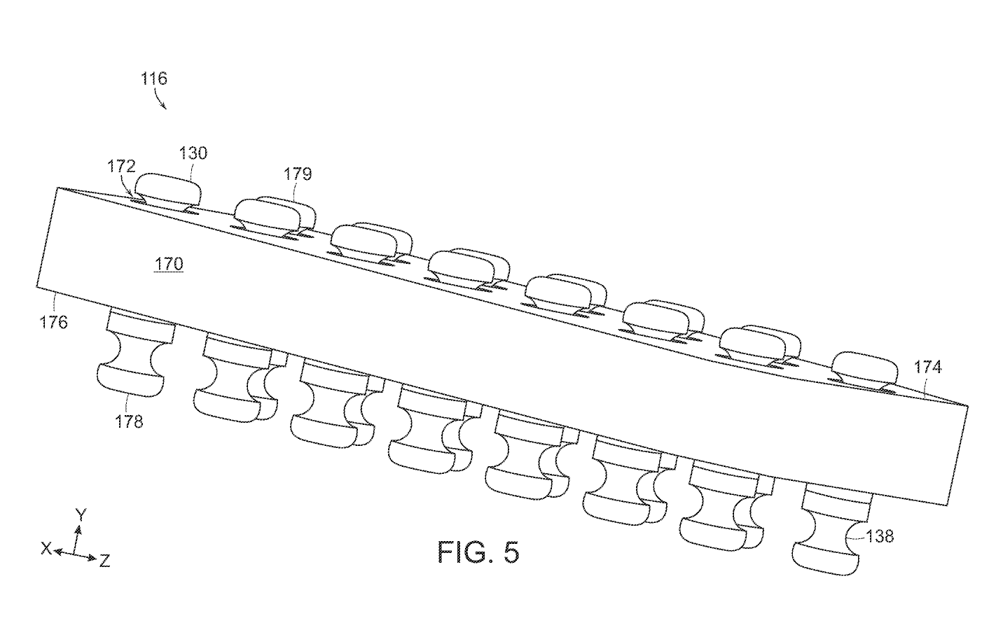

Referring to FIGS. 2B and 5, male assembly 116 includes an insulative support member 170 and male contacts 130. Insulative support member 170 of male assembly 116 and the second plurality of apertures 172 that extend from a first broad face 174 of insulative support member 170 to an opposite second broad face 176 of insulative support member 170. Apertures 172 are sized receive male contacts 130 in a press-fit engagement.

Male contacts 130 are in the form of pins and have an axis Aₘ extending from a first end 178 to a second end 179. First end 178 of each male contact 130 is configured to engage contact area 128 of a corresponding resilient member 122. Each male contact 130 includes a retention feature (e.g., groove 138) configured to engage retention feature 136 on a corresponding resilient member 122. In other embodiments, each male contact 130 include other retention features. Some embodiments of male contacts include other retention features such as, for example, a protrusion extending outward from the surface of the male contact, a protrusion designed to engage a groove on a corresponding resilient member. Some embodiments of terminals do not include any retention features.

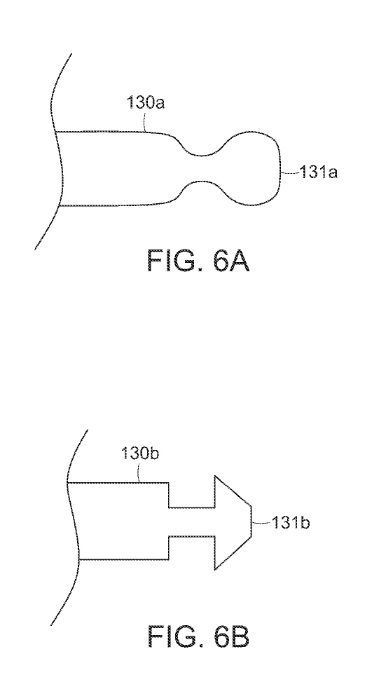

For example, referring to FIGS. 6A and 6B, male contacts 130 can have different head shapes. As shown in FIGS. 6A and 6B, ends 131a, 131b of male contacts 130a, 130b are bulbous and trapezoidal in cross-section, respectively. Similarly, first and second ends 124, 126 of resilient member 122 can have different shapes than those illustrated in FIGS. 2B-3B. For example, second end 126 could be formed with a rectangular shape (not shown) configured to match the recess defined by the contact head shown in FIG. 6B. Adjusting the shapes of first and second ends 124, 126 of resilient member 122 and/or the shape of male contact 130 can adjust the contact area and the force required for insertion or withdrawal of male assembly 116 from engagement with female assembly 114.

Each male contact 130 also includes a pair of barbs 180a, 180b that protrudes radially outward relative to an outer cylindrical surface 182 of male contact 130. Outer cylindrical surface 182 has a transverse cross-sectional area in a slightly smaller than the transverse cross-sectional area of aperture 172. Barbs 180a, 180b have tapered surfaces that increase in radius with increasing distance from first end 178 of male contacts 130. In some embodiments, second end 179 includes a head for receiving solder paste or a solder ball. Second end 179 defines a shoulder configured to engage second broad face 176 of male assembly 116 when male contacts 130 are inserted into apertures 172.

Insulative support member 170 is molded of an electrically insulative thermoplastic (e.g., liquid crystal polymer). First ends 178 of male contacts 130 are inserted into apertures 172 past second broad surface 176. Male contacts 130 are pressed into apertures 172. Protrusion 180 provides a friction fit that can hold male contacts 130 in place in insulative support member 170. In some embodiments, protrusions 180 are supplemented with or placed by an adhesive to hold male contacts 130 in place. First ends 178 of male contacts 130 extends past first broad face 174 of male assembly 116.

A number of embodiments of the invention have been described. Nevertheless, it will be understood that various modifications may be made without departing from the spirit and scope of the invention. For example, in some embodiments, intercoupling components are assembled with terminals 118 all have the same orientation (in contrast to the alternating configuration shown). Accordingly, other embodiments are within the scope of the following claims.

What is claimed is:

1. An assembly comprising:
a first insulative support member defining a first plurality of apertures extending from first surface of the first insulative support member to an opposite second surface of the first insulative support member; and
a plurality of terminals received in the apertures, each terminal comprising a resilient member extending from a first end to a second end, the first end including a contact portion configured to engage a male contact and the second end including a retention feature configured to engage the male contact and hold the male contact in place against a first force applied to the male contact by the first end.

2. The assembly of claim 1, wherein the first end is configured to apply the first force substantially along a longitudinal axis of the male contact.

3. The assembly of claim 2, wherein the second end is configured to apply a second force substantially transverse to the longitudinal axis of the male contact.

4. The assembly of claim 1, further comprising:
a second insulative support member defining a second plurality of holes extending from a first surface of the second insulative support member to an opposite second surface of the second insulative support member; and
a plurality of male contacts received in the apertures.

5. The assembly of claim 4, wherein each male contact comprises a surface feature configured to engage the retention feature of a corresponding one of the plurality of terminals.

6. The assembly of claim 1, wherein the resilient member of each terminal defines an axis and the plurality of terminals are disposed such that axes of the terminals are substantially parallel.

7. The assembly of claim 6, wherein adjacent terminals of the plurality of terminals are disposed within the first insulative support member with opposite orientations.

8. The assembly of claim 1, wherein the resilient member comprises a first leg, a second leg, and a transition region, the first leg attached to the second leg by the transition region such that the first leg is substantially parallel to the second leg when the terminal is in an unconstrained rest position.

9. The assembly of claim 8, wherein each terminal further comprises a base attached to the first leg, the base spaced apart from the contact portion by a first distance and the base spaced apart from the transition region by a second distance that is greater than the first distance.

10. The assembly of claim 9, wherein the resilient member further comprises a third leg extending substantially linearly from the first leg to the second end, the third leg attached to the first leg such that the third leg is substantially perpendicular to the first leg in the first position.

11. The assembly of claim 10, wherein the third leg has a length that is greater than the first distance.

12. A terminal comprising:
an electrically conductive resilient member extending from a first end to a second end, the first end including a contact portion configured to engage a male contact and the second end including a retention feature configured to engage the male contact and hold the male contact in place against a first force applied to the male contact by the first end.

13. The terminal of claim 12, wherein the first end is configured to apply the first force substantially along a longitudinal axis of the male contact.

14. The terminal of claim 13, wherein the second end is configured to apply a second force transverse to the longitudinal axis of the male contact.

15. The terminal of claim 12, wherein the resilient member comprises a first leg, a second leg, and a transition region, the first leg attached to the second leg by the transition region such that the first leg is substantially parallel to the second leg when the terminal is in a first position.

16. The terminal of claim 15, further comprising a base attached to the first leg, the base spaced apart from the contact portion by a first distance and the base spaced apart from the transition region by a second distance that is greater than the first distance.

17. The terminal of claim 16, wherein the resilient member further comprises a third leg extending substantially linearly from the first leg to the second end, the third leg attached to the first leg such that the third leg is substantially perpendicular to the first leg in the first position.

18. The terminal of claim 17, wherein the retention feature is a protrusion extending outward from the third leg.

19. The terminal of claim 16, further comprising a male contact extending from the base on a first side of the base opposite a second side of the base to which the resilient member is attached.

20. The terminal of claim 15, wherein the first position is an unconstrained rest position.

21. An assembly comprising:
a first insulative support member defining a first plurality of apertures extending from first surface of the first insulative support member to an opposite second surface of the first insulative support member;
a plurality of terminals received in the apertures, each terminal comprising a resilient member extending from a first end to a second end, the first end configured to apply the first force substantially along an axis of the male contact, the first end including a contact portion configured to engage a male contact and the second end configured to apply a second force substantially across the axis of the male contact, the second end including a retention feature configured to engage the male contact and hold the male contact in place against a first force applied to the male contact by the first end;
a second insulative support member defining a second plurality of holes extending from a first surface of the second insulative support member to an opposite second surface of the second insulative support member; and a plurality of male contacts received in the apertures, each male contact comprising a surface feature configured to engage the retention feature of a corresponding terminal.

22. The assembly of claim 21, wherein the resilient member of each terminal defines an axis and the plurality of terminals are disposed such that axes of the terminals are substantially parallel and adjacent terminals of the plurality of terminals are disposed with opposite orientations.

23. The assembly of claim 21, wherein the resilient member comprises a first leg, a second leg, and a transition region, the first leg attached to the second leg by the transition region such that the first leg is substantially parallel to the second leg when the terminal is in an unconstrained rest position.

24. The assembly of claim 23, wherein the resilient member further comprises a third leg extending substantially linearly from the first leg to the second end, the third leg attached to the first leg such that the third leg is substantially perpendicular to the first leg in the first position.
